(19) United States
(12) Patent Application Publication
(10) Pub. No.: US 2020/0172121 A1
(43) Pub. Date: Jun. 4, 2020

(54) METHOD AND SYSTEM FOR PROVIDING RECOMMENDATIONS DURING VEHICLE NAVIGATION

(71) Applicant: Wipro Limited, Bangalore (IN)

(72) Inventors: Vivek Gonchikar Krishnappa, Bangalore (IN); Sabdharishi Natarajan, Banagalore (IN); Debasish Chanda, Maheshtala (IN)

(21) Appl. No.: 16/258,136

(22) Filed: Jan. 25, 2019

(30) Foreign Application Priority Data
Nov. 30, 2018 (IN) 201841045413

(51) Int. Cl. B60W 50/14; B60W 40/06; G06F 17/18

(52) U.S. Cl. CPC B60W 50/14; B60W 40/06; B60W 2550/408; B60W 2050/143; G06F 17/18

(57) ABSTRACT

The present disclosure relates to a recommendation engine and a method for providing recommendations during navigation of the vehicle on a road. The recommendation engine provides recommendations in real-time to one or more occupants of the vehicle. The recommendation engine receives data related to the vehicle and environment surrounding the vehicle in real-time. The date along with a historical data set regarding the road is used to generate a training set corresponding to a plurality of conditions of the road. Thereafter, the training set is used to create a multi-variate regression model. The multi-variate regression model is applied on the received data for detecting a condition of the road during navigation of the vehicle. The detected condition of the road is used for providing one or more recommendations to the one or more occupants of the vehicle.

This application claims the benefit of Indian Patent Application Serial No. 201841045413, filed Nov. 30, 2018, which is hereby incorporated by reference in its entirety.

### FIELD

The present disclosure relates in general to driver assistance. Particularly, but not exclusively, the present disclosure relates to providing recommendations to a driver during vehicle navigation.

### BACKGROUND

The number of vehicles on roads is increasing at rapid rate. This leads to increased stress on road infrastructure. Poor roads lead to accidents and thus there is a necessity to improve condition of roads. However, in developing countries, improving roads can consume time. Therefore, travelling on poor roads has proven to be fatal.

Existing road infrastructure monitoring strategy typically depends on manual inspection and Closed-Circuit Television (CCTV) footages or any image processing software. Such inspection is ad-hoc and depends on accuracy of CCTV. Thus, such inspection may not be reliable.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In one embodiment, the present disclosure relates to a method of providing recommendations during vehicle navigation. The method comprises receiving data related to a vehicle and environment surrounding the vehicle. The data may be received from a plurality of sensors associated with the vehicle. The data is used to generate a training set for a plurality of conditions of the road. Also, a historical data set related to the road may be sued to generate the training set. Further, a multi-variate regression model is created using the training set. Applying the multi-variate regression model on the received data, a condition of the road from the plurality of conditions of the road is detected. Upon detecting the condition of the road, one or more recommendations are provided to one or more occupants of the vehicle.

In an embodiment, the present disclosure relates to a recommendation engine for providing recommendations during vehicle navigation. The recommendation engine comprises a processor and a memory. The processor is configured to receive data related to a vehicle and environment surrounding the vehicle, from a plurality of sensors. In an embodiment, the data may be received during navigation of the vehicle on a road. Further, the processor is configured to generate a training set for a plurality of conditions of the road. Further, the processor is configured to create a multi-variation regression model for detecting a condition of the road from the plurality of conditions of the road. Thereafter, the processor is configured to provide one or more recommendations to one or more occupants of the vehicle, based on the detected condition of the road.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary block diagram of a recommendation engine, in accordance with an embodiment of the present disclosure;

FIG. 2 illustrates internal modules of road condition capture unit, in accordance with an embodiment of the present disclosure;

FIG. 3 illustrates internal modules of road condition monitoring unit, in accordance with an embodiment of the present disclosure;

FIG. 4 illustrates internal modules of road condition warning unit, in accordance with an embodiment of the present disclosure; and

FIG. 5 illustrates an exemplary flow chart for providing recommendations during vehicle navigation, in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a recommendation engine and a method for providing recommendations during navigation of the vehicle on a road. In an embodiment, the recommendation engine resides inside the vehicle. In an embodiment, the recommendation engine provides recommendations in real-time to one or more occupants of the vehicle. The recommendation engine receives data related to the vehicle and environment surrounding the vehicle in real-time. The date along with a historical data set regarding the road is used to generate a training set corresponding to a plurality of conditions of the road. Thereafter, the training set is used to create a multi-variate regression model. The multi-variate regression model is applied on the received data for detecting a condition of the road during navigation of the vehicle. The detected condition of the road is used for providing one or more recommendations to the one or more occupants of the vehicle. The one or more occupants may be provided with an alternate road. In an embodiment, a warning may be provided, thus alerting the one or more occupants.

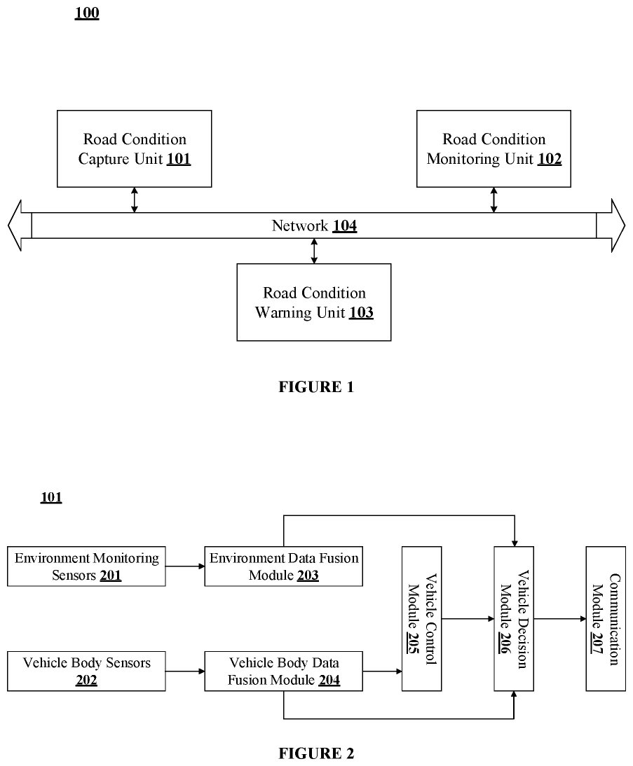

FIG. 1 shows an exemplary block diagram of a recommendation engine (100). The recommendation engine (100) may comprise a road condition capture unit (101), a road condition monitoring unit (102), a road condition warning unit (103) and a network (104).

In an embodiment, the road condition capture unit (101) may be configured to capture data related to the vehicle and environment surrounding the vehicle. Further, the road condition capture unit (101) may be configured to provide the captured the data to the road condition monitoring unit (102) for further processing. In an embodiment, data related to the vehicle may include but is not limited to, location of the vehicle, speed of the vehicle, acceleration of the vehicle, braking of the vehicle, vehicle swerves, vibrations in the vehicle, and the like. In an embodiment, data related to the environment may include but are not limited to, weather, illumination, environmental data received from sensors like Long Range Radar (LRR), Short Range Radar (SRR), laser, Infra-Red (IR) sensors, ultrasound sensors, cameras, any other sensors used in autonomous vehicles that are used to obtain environmental data.

In an embodiment the road condition monitoring unit (102) may be configured to receive the data related to the vehicle and the data related to the environment surrounding the vehicle and monitor condition of the road. Road conditions may include but are not limited to, patchy roads, roads with potholes, roads with obstacles, skiddy roads, and the like. The road condition is constantly monitored to detect if the road is suitable for the vehicle to navigate.

In an embodiment, the road condition warning unit (103) may be configured to provide warnings to occupants of the vehicle upon detecting a condition of the road that is not suitable for navigating. For example, if the vehicle is moving on a road covered with snow, then the road condition warning unit (103) may provide a warning to driver of the vehicle indicating that the road is not suitable for driving.

In an embodiment, the road condition capture unit (101), the road condition monitoring unit (102), and the road condition warning unit (103) may communicate with each other over the network (104). The network (104) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc.

Reference is now made to FIG. 2 which shows internal modules of the road condition capture unit (101). The road condition capture unit (101) may include environment monitoring sensors (201), vehicle body sensors (202), environmental data fusion module (203), vehicle body data fusion module (204), vehicle control module (205), (vehicle decision module (206), and communication module (207).

In an embodiment, environment monitoring sensors (201) may be configured to capture data from various environment monitor sensor such as LRR, SRR, lasers, IR sensors, ultrasonic sensors, external cameras, thermal sensors, luminescence sensors, and sensors alike.

The vehicle body sensors (202) may be configured to capture data such as acceleration of the vehicle, vehicle speed, vehicle breaking, vehicle swerves, vehicle vibration, or vehicle location. The vehicle body sensors (202) may include but may not be limited to accelerometer, Global Position System (GPS), brake sensors, vibration sensors, and so on.

In an embodiment, the environment data fusion module (203) may be configured to synthesize the data captured by environment monitoring sensors (201) and may fuse the data into a form that can be used for decision making. The captured data may be validated before fusion process. Environment data fusion module (203) may also be configured to receive data/warnings from the road condition warning unit (103) and broadcast the warning to all other vehicles in the vicinity of the vehicle. For example, if the vehicle is surrounded by two other vehicles, then the warnings provided to the two vehicles in the vicinity of the vehicle. The environment data fusion module (203) may synthesize the data captured by vehicle body sensor (202). The environment data fusion module (203) may capture all the relevant data at periodic/appropriate time interval which may be an input to the vehicle control module (205) to process further.

The vehicle control module (205) module may calibrate or scale the environment or vehicle body data based on make of the vehicle, model of the vehicle, type of the vehicle. Based on the vehicle type (car, pick-up truck, Multi-Utility vehicle (MUV), Sports Utility Vehicle (SUV), sedan, luxury vehicle and the like), type of roads like roads having potholes/speed breakers/slush road/gravel road/mud road/mountain terrain, desert road may generate different set of readings from the vehicle body sensors (202). Within the same vehicle type, different make/model/brand different set of readings from the vehicle body sensors (202) may be generated. The vehicle control module (205) may normalize the vehicle body sensors (202) readings based on the predetermined normalization calibration charts depending on the vehicle type/make/model/brand. The calibrated values may be sampled and averaged over a period of time.

The vehicle decision module (206) module will generate road-condition related data (such as bump, pothole, smooth road) based on the input from the environment data fusion module (203), vehicle data fusion module (204) and vehicle control module (205). The vehicle decision module (206) may filter variations/false data in the parameters that may shows up from the vehicle body sensors (202) indicating pothole/bump or type of road.

The condition of the road may be numerically represented as a number ranging from 1−n. In an example embodiment, 1 may denote an excellent condition road infrastructure and n may denote a worst condition road infrastructure. This may be called as the Normalized Road Condition Classification (NRC) value. The value “n” may be arrived upon by considering the various parameters such as the granularity/accuracy/system capability. The NRC may be calculated as shown in equation 1 below:

NRC−fn (vehicle sensors data) (1)

The minimum parameters that may be recorded from the vehicle sensors are vehicle speed, breaking, orientation, vibrations and the accelerometer readings. The roads may be classified into different categories such as highway, expressway, city roads, state highways, mountain terrain roads, and the like which may have different requirements of the NRC for classifying the road as Good/OK/Bad/Need Repair. The data received from the vehicle control module (205) may be periodically collected and sent to a central road condition monitoring system (not shown in figure). The central road condition monitoring system may be remote to the vehicle. The central road monitoring system may receive the data from a plurality of vehicle navigating a road and analyze the data to detect a condition of the road. Such analysis may be used to update a map for providing alternate routes. The vehicle decision module (206) may make decisions based on the variations in collected sensor data if the collected sensor data is classified as a bump/pothole. In an embodiment, the vehicle decision module (206) may use machine learning techniques to make decisions. A person of skilled in the art may appreciate that the vehicle decision module (206) may comprise sub-modules required to implement machine learning techniques. In an embodiment, the vehicle decision module (206) may provide decisions in real-time.

In an embodiment, the communication module (207) may share the road-condition data to road condition monitoring unit (102) using communication mechanism such as Vehicle to Infrastructure (V2I) or Vehicle to Vehicle (V2V) or Telematics protocol.

The communication module (207) may format the data received from the vehicle decision module (206), store the data locally or in cloud storage and communicate the data to the road condition monitoring unit (102). In an embodiment, the data may have vehicle Identity (ID), date/time the data is collected, location of the vehicle, vehicle type/modem/make, and NRC values.

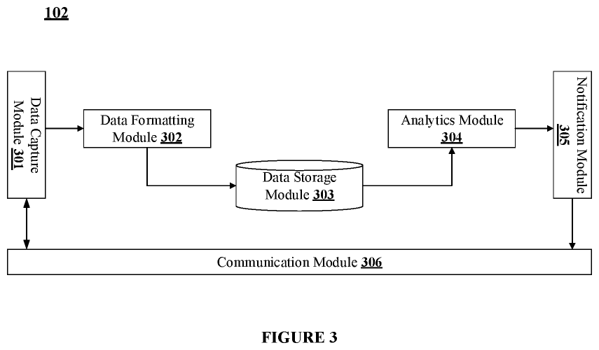

Reference is now made to FIG. 3. FIG. 3 illustrates internal modules of the road condition monitoring unit (102). The road condition monitoring unit (102) may comprise a data capture module (301), a data formatting module (302), a data storage module (303), analytics module (304), notification module (305), and a communication module (306).

In an embodiment, the communication module (306) is responsible for communicating with each vehicle. It is also responsible for authentication.

In an embodiment, the data capture module (301) may capture road condition data from the road condition capture unit (101). The data captured may be real time data from or data saved locally in the vehicle.

In an embodiment, the data formatting module (302) may format road condition data for the processing. In an embodiment, the data storage module (303) may store the road condition data in formatted form. The data received may be further processed and additional information regarding the classification of the road (city/town/village/state highway/national highway/mountain terrain/mud road) may also be added based on the GPS location.

In an embodiment, vehicle ID may be derived from vehicle information number, vehicle model/make and the natural region of operation of the vehicle.

In an embodiment, the analytics module (304) may analyze real-time road condition data and may understand trend/pattern to detect the road condition. The analytics module (304) may also have functionality of filtering false/spurious/malicious entries based on majority data readings. The analytics module (304) may be present in both edge (vehicle) or on the central monitoring system. The analytics module (304) may be configured in the vehicle to provide immediate warnings when the road is bad as well as data can be shared to the central monitoring system.

In an embodiment, the notification module (305) may notify the analyzed data to the occupants of the vehicle. In an embodiment, the notification module (305) may also notify other vehicles regarding the detected condition. The notifications provided may be continuous or may be periodic.

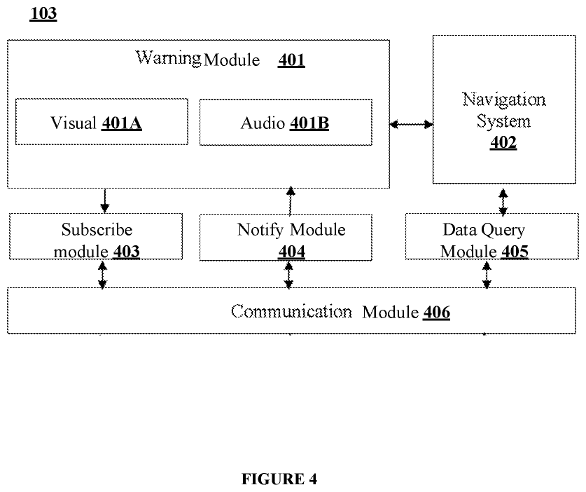

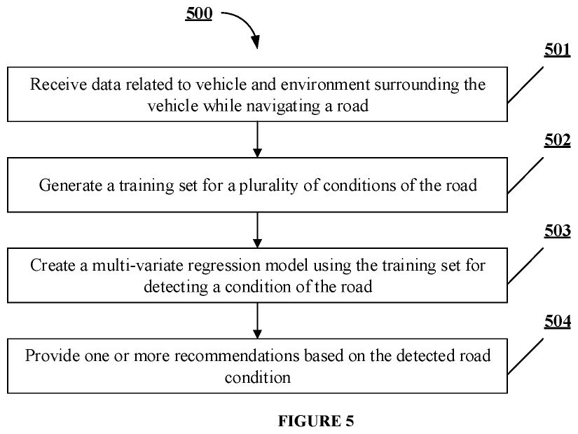

FIG. 4 illustrates internal modules of the road condition warning unit (103). The road condition warning unit (103) may comprise a warning module (401), a navigation system (402), a subscribe module (403), a notify module (404), a data query module (405), and a communication module (406).

In an embodiment, the communication module (406) may receive data from the road condition monitoring unit (102). In an embodiment, the communication module (406) may communicate with the road condition monitoring unit (102) through the communication network 104. The communication module (406) may employ connection protocols including, without limitation, direct connect, Ethernet (for example, twisted pair 10/100/1000 Base T), transmission control protocol/Internet protocol (TCP/IP), token ring, IEEE 802.11a/b/g/n/x, etc. The communication network 104 may include, without limitation, a direct interconnection, wired connection, e-commerce network, a peer to peer (P2P) network, Local Area Network (LAN), Wide Area Network (WAN), wireless network (e.g., using Wireless Application Protocol (WAP)), the Internet, Wireless Fidelity (Wi-Fi), and the like.

In an embodiment, the subscribe module (403) may provide periodic alerts to occupants of the vehicle regarding the condition of the road via the notify module (404). Also, the alerts may be provided to the central monitoring system.

In an embodiment, the data query module (405) may query and obtain specific data from the road condition monitoring unit (102). For example, if a driver has subscribed for periodic alerts regarding condition of a road, the data query module (405) may query the road condition monitoring unit (102) periodically and obtain the condition of the road.

In an embodiment, the warning module (401) may provide visual (401A) warnings or audio (401B) warnings or a combination thereof. In an embodiment, the navigation system (402) may generate alternate routes for the vehicle to navigate from a source to a destination if the condition of the road falls into a category which cannot be navigated by the vehicle.

All the above modules may include at least one Central Processing Unit (“CPU” or “processor”) and a memory storing instructions executable by the at least one processor. The processor may comprise at least one data processor for executing program components for executing user or system-generated requests. The memory is communicatively coupled to the processor. The processor may be associated with an Input/Output (I/O) interface. The I/O interface is coupled with the processor through which an input signal or/and an output signal is communicated.

As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The modules when configured with the functionality defined in the present disclosure will result in a novel hardware.

FIG. 5 shows a flow chart illustrating a method for providing recommendations during vehicle navigation, in accordance with some embodiments of the present disclosure.

As illustrated in FIG. 5, the method 500 may comprise one or more steps for providing recommendations during vehicle navigation, in accordance with some embodiments of the present disclosure. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 501, the recommendation engine (100) may receive data related to the vehicle and environment surrounding the vehicle, while the vehicle is navigating a road. The data may be received from the environmental sensors (201) and the vehicle body sensors (202).

Considering n=Total number of environmental sensors, environmental sensor set (ES) may be defined as follows:

ES={ES1, . . . , ESn}

where ESi may indicate reading i^{th} environmental sensor
m=Total number of vehicle body sensors, vehicle body sensor Set (BS) may be defined as follows:

BS={BS1, . . . , BSm} where BSi indicates reading it^{h} vehicle body sensor.

In an embodiment, the sensor data may be fused to provide realistic representation. A data set having fused data may be represented as “S”. Thereafter, the vehicle parameters are determined such as make of the vehicle, model of the vehicle, and the like. Considering z=total number of vehicle parameters, vehicle parameter set (V) may be defined as:

V={V₁, . . . ,V_{Z}};

where V_{Z} may indicate z^{th} vehicle parameter.

At step 502, the recommendation engine (100) may generate a training set for a plurality of conditions of the road. In an embodiment, the training set may be created when the vehicle navigates through different types of road condition (such as road with bumps, potholes, obstacles, skiddy). For example, let us consider y=total number of road conditions. A road conditions set (RC) may be defined as:

RC={RC₁, . . . ,RC_{y}}; where RC_{y} may indicate y^{th} road condition parameters.

In an embodiment, a historic data set may be used for generating training set RC. The historic data set may include historical data related to the road condition. For example, data collected by a plurality of vehicles navigated through the road may be collected by the central monitoring system. The recommendation engine (100) may obtain the historical data set from the central monitoring system.

At step 503, the recommendation engine (100) may create a multi-variate regression model using the training set generated using the data. In an embodiment, supervised learning techniques may be employed in generating the multi-variate regression model. In another embodiment, unsupervised techniques may be employed. In an embodiment, the multi-variate model may be created by the recommendation engine (100) and the central monitoring system. The recommendation engine (100) may use less training set and the central monitoring system may use more training set received from a plurality of vehicles. The recommendation engine (100) may use the multi-variate model to detect the condition of the road. The recommendation engine (100) uses the data received from the sensors (201 and 202) and may apply the multi-variate model to detect the condition of the road. In an embodiment, the condition of the road may be detected from the pre-classified conditions of the road. In an embodiment, if the condition of the road is new and not among the pre-classified conditions, the new condition if the road is stored and used for future decision making. In an embodiment, standard map matching technique is used to combine electronic map with location information to obtain real position of vehicles in a road network.

At step 504, the recommendation engine (100) provides one or more recommendations to the one or more occupants of the vehicle. In an embodiment, the one or more recommendations may include an alternate path, a warning indication, periodic notifications, and the like.

In an embodiment, if the condition of the road is bad and if the vehicle cannot navigate the road, the recommendation engine (100) may recommend an alternate path to the one or more occupant. In an embodiment, the alternate path may also be recommended to map vendors to recommend similar alternate path to other vehicles and users. In an embodiment, the alternate path may also be stored in the central monitoring system. In an embodiment, the alternate path may also be communicated to other vehicles/nearby infrastructures using V2V protocols/V2I protocols.

In an embodiment, the recommendation engine (100) may provide warning to the one or more occupants. For example, if a land slide has occurred, the recommendation engine (100) may provide a warning. The driver of the vehicle may take immediate action to surpass the road. In an embodiment, the warning may also be provided to other vehicles.

In an embodiment, the recommendation engine (100) may provide periodic notification about a road. For example, if a driver has requested for periodic traffic update, the recommendation engine (100) may provide periodic notifications about the traffic.

In an embodiment, the recommendations are useful to avoid certain roads with bad conditions. In an embodiment, the warnings help reduce accidents and such warnings and recommendations are provided to other vehicles which helps in traffic management.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of providing recommendations during vehicle navigation, the method comprising:
receiving, by a recommendation engine, data related to a vehicle and environment surrounding the vehicle, from a plurality of sensors while the vehicle is navigating a road;
generating, by the recommendation engine, a training set for a plurality of conditions of the road based on the plurality of data related to the environment, vehicle and a historical data set;
creating, by the recommendation engine, a multi-variate regression model using the training set for detecting a condition of the road from the plurality of conditions of road; and
providing, by the recommendation engine, one or more recommendations to one or more occupants of the vehicle based on the detected condition of the road, wherein the recommendations provided are used for navigating the road.

2. The method of claim 1, wherein the one or more recommendations comprises recommending an optimal route to navigate from a source to a destination, wherein the optimal route is updated based on a change in condition of the road during navigation, wherein the updated route and the detected condition of the road is communicated to at least one of, an occupant in the vehicle and one or more vehicles approaching the vehicle.

3. The method of claim 1, further comprising providing warnings about the condition of the road to a user through one of audio, visual or text modes.

4. The method of claim 1, wherein the data related to environment comprises notifications indicative of the condition of the road, sent by other vehicles.

5. The method as claimed in claim 1, wherein the plurality of sensors comprises vehicle body sensors and environmental monitoring sensors.

6. The method of claim 1, wherein the data related to the vehicle and the environment is calibrated before generating the training set.

7. The method of claim 1, wherein the data related to the vehicle is normalized based on predetermined normalization calibration charts depending on a type, a make, a model or a brand of the vehicle.

8. The method of claim 8, wherein the environment monitoring sensors comprise at least one of Long-Range Radar, Short-Range Radar, Laser, Infrared Sensor, Ultrasonic or image sensors.

9. The method of claim 8, wherein the vehicle body sensors comprise at least one of accelerometer, vehicle speed sensor, vehicle brake sensor, vehicle collision sensor, vehicle vibration sensor, or Global Positioning System (GPS).

10. A recommendation engine for providing recommendations during vehicle navigation, the system comprising:
a processor; and
a memory communicatively coupled to the processor, wherein the memory stores processor instructions, which, on execution, cause the processor to:
receive data related to the vehicle and environment surrounding the vehicle from a plurality of sensors in real-time;
generate a training set for a plurality of conditions of the road based on the plurality of data related to the environment, vehicle and a historical data set;
create a multi-variate regression model using the training set for detecting a condition from the plurality of conditions of the road; and
provide one or more recommendations to one or more occupants of the vehicle based on the detected condition of the road, wherein the recommendations provided are used for navigating the road.

11. The recommendation engine of claim 10, wherein the processor provides recommends an optimal route for the vehicle based on the condition of the road to navigate from a source to a destination, wherein the generated route is updated based on change in condition of the road during navigation, wherein the updated route and the detected condition of the road is communicated to at least one of, an occupant in the vehicle and one or more vehicles approaching the vehicle.

12. The recommendation engine of claim 10, wherein the plurality of sensors comprises vehicle body sensors and environmental monitoring sensors.

13. The recommendation engine of claim 10, wherein the processor is configured to calibrate the data related to the vehicle and the environment before generating the training set.

14. The recommendation engine of claim 10, wherein the processor is configured to normalize the data related to the vehicle based on predetermined normalization calibration charts depending on a type, a make, a model or a brand of the vehicle.

15. The recommendation engine of claim 10, wherein the processor is configured to provide warnings about the condition of the road to the occupant through one of audio, visual or text modes.

16. The recommendation engine of claim 12, wherein the environment monitoring sensors comprise at least one of Long-Range Radar, Short-Range Radar, Laser, Infrared Sensor, Ultrasonic or image sensors.

17. The recommendation engine of claim 12, wherein the vehicle body sensors comprise at least one of accelerometer, vehicle speed sensor, vehicle brake sensor, vehicle collision sensor, vehicle vibration sensor, or Global Positioning System (GPS).
